(19) United States
(12) Patent Application Publication
(10) Pub. No.: US 2001/0030504 A1
(43) Pub. Date: Oct. 18, 2001

(54) Beam index type cathode ray tube

(76) Inventors: Sung-Soo Lee, Seoul (KR); Jae-Ho Lee, Ansan-city (KR); Jong-Sik Choi, Suwon-city (KR)

Correspondence Address: STAAS & HALSEY LLP, 700 11TH STREET, NW, SUITE 500, WASHINGTON, DC, 20001, US

(21) Appl. No.: 09/794,387

(22) Filed: Feb. 28, 2001

(30) Foreign Application Priority Data
Mar. 13, 2000 (KR) 2000-12506

(51) Int. Cl. H01J 29/70; H01J 29/10

(52) U.S. Cl. 313/471; 313/421

(57) ABSTRACT

A beam index type cathode ray tube having an improved alignment of index stripes, phosphor stripes and matrix stripes. An alignment of the index stripes, the color stripes and the matrix stripes is confirmed during an exposure processing state of the index stripes by using confirming points formed in the screen. An exposed state of the screen is determined by optically testing an alignment of the confirming points and a master screen. On determining that a misalignment exists, the relative positions of the screen and the master screen are adjusted to remove the misalignment.

### CROSS REFERENCE TO RELATED APPLICATIONS

This application claims the benefit of Korean Application No. 00-12506 filed Mar. 13, 2000, in the Korean Patent Office, the disclosure of which is incorporated herein by reference.

### BACKGROUND OF THE INVENTION

1. Field of the Invention

The present invention relates to a beam index type cathode ray tube, and more particularly, to a beam index type cathode ray tube in which a process of forming a screen on an inner surface of a panel is improved.

2. Description of the Related Art

A beam index type cathode ray tube is designed to reduce problems of a general cathode ray tube. The beam index type tube senses index signals generated by an electron beam and synchronizes the sensed index signals with color signals, such that the electron beam always arrives at a phosphor material at a desired location on a screen to obtain an image.

The beam index type cathode ray tube forms index stripes generating index light from the screen which is formed on an inner surface of the panel, and the index stripes are generally formed on an aluminum film of the screen with a predetermined interval.

A method of forming the index stripes is realized by applying a slurry for index stripes on an aluminum film, and exposing the slurries to cleaning after evaporating the aluminum film in the procedure of manufacturing the screen. The index stripes are patterned by using a master glass pattern mask in the exposing process.

That is, the master glass pattern mask serves as a shadow mask for exposing, which is used in the procedure of manufacturing a screen of a general cathode ray tube, wherein location and width of the index stripes are determined according to an actual mounting state of the master glass pattern mask when setting exposing areas, and therefore, the mounting state of the master glass pattern mask is important to form an excellent screen.

The cathode ray tube is formed with a glass tube which maintains an inner atmosphere in a high vacuum state, but it is possible to know a state of a screen, which is realized in the screen, only after completing the final manufacturing process. Therefore, it is desirable to prevent the loss of manufacturing costs by checking the screen for defects in an initial state.

Accordingly, in the process of manufacturing a general cathode ray tube, the manufacturing defects have been prevented by continuously checking an exposed state of the screen with a microscope or other sensors which sense light released outside from a panel through a light source of an exposed stand in the exposing process.

While in the process of manufacturing the beam index type cathode ray tube, it is impossible to confirm the exposed state of the index stripes by confirming light released outside from the panel through a light source, since the light beams cannot be released from the panel due to an aluminum film, which is formed under the index stripes. Therefore, the exposed state of the index stripes has been confirmed not in an initial stage but in a screen test stage for determining the quality of color reproduction after completing the manufacturing.

The related art method for manufacturing the beam index type cathode ray tube has disadvantages that manufacturing cost is wasted or increased for confirming the exposed state. Even though the index stripes are exposed in an erroneous mounting state of the master glass pattern mask, such a mistake may be detected or rectified not in the initial stage but only after finishing the manufacturing process.

### SUMMARY OF THE INVENTION

Therefore, an object of the present invention is to resolve the above disadvantages and problems of the related art and to provide a beam index type cathode ray tube, in which an exposed state of an index strip may be promptly checked during an exposing process so that manufacturing defects due to exposure errors may be prevented.

Additional objects and advantages of the invention will be set forth in part in the description which follows, and, in part, will be obvious from the description, or may be learned by practice of the invention.

In order to achieve the above and other objects of the present invention, a beam index type cathode ray tube includes a tube, the inside of which is maintained in a vacuum state. A screen is formed at one side in the tube, the screen comprising phosphor stripes, a black matrix, an aluminum film and index stripes. An electron gun is installed in the tube toward the screen and a deflection unit is installed in the tube to deflect an electron beam emitted by the electron gun to the screen. A detector is installed in the tube to sense light emitted by the index stripe and confirming points are formed in the screen for confirming an exposed state of the screen.

The confirming points are preferably formed in an ineffective area of the screen. The conforming points are formed free of the aluminum film and preferably in a similar manner as the phosphor stripes and the black matrix. In the process of exposing a photosensitive slurry to form the index stripes, the alignment of a master mask and the black matrix is controlled by observing light passing through both the master mask and the confirming points or by observing light emitted by the phosphor stripes of the confirming points.

### BRIEF DESCRIPTION OF THE DRAWINGS

The above object other objects of the present invention will become more apparent by describing in detail embodiments thereof with reference to the attached drawings in which:

FIG. 1 is a side cross-sectional view of a beam index type cathode ray tube according to the present invention;

FIG. 2 is a front view of a beam index type cathode ray tube for explaining a structure of a screen part according to the present invention;

FIG. 3 is a partial cross-sectional view for explaining the structure of the screen part according to the present invention;

FIG. 4 is a detailed view of a part A of FIG. 2;

FIG. 5 is a detailed view of a part B of FIG. 2;

FIG. 6 is a cross-sectional view for explaining an exposing process of index stripes according to the present invention;

FIG. 7 is a conceptional view for showing a false exposure toward an R phosphor stripe; and

FIG. 8 is a conceptional view for showing a false exposure toward a G phosphor stripe.

### DETAILED DESCRIPTION OF THE PREFERRED EMBODIMENT

Reference will now be made in detail to the embodiment of the present invention, examples of which are illustrated in the accompanying drawings, wherein like reference numerals refer to like elements throughout.

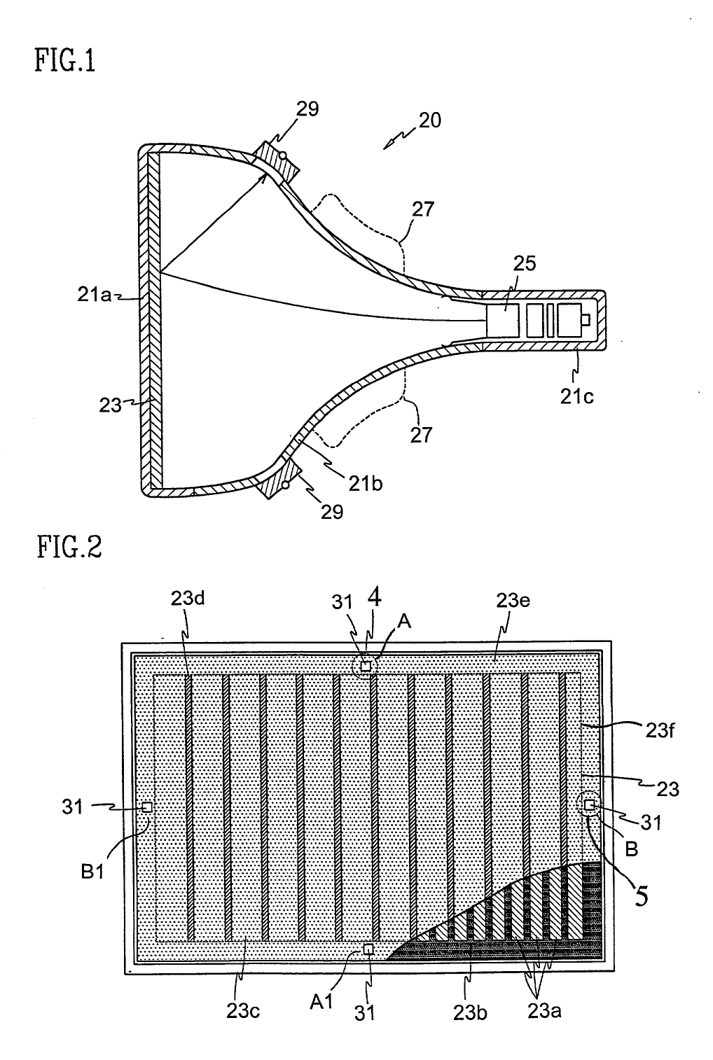

FIG. 1 is a perspective view of a beam index type cathode ray tube according to the present invention and FIG. 2 is a front view of an inner panel for explaining a screen part according to the present invention. Referring now to FIGS. 1 and 2, a cathode ray tube 20 is formed with a panel 21a forming a front glass, a funnel 21b formed contiguous to a rear part of the panel 21a, and a neck 21c contiguous to the rear part of the funnel 21b. A vacuum state is maintained inside the cathode ray tube 20.

On the inside of the panel 21a of the tube 20, a screen 23 including red R, green G and blue B phosphor stripes 23a is formed, a black matrix 23b is arranged between the phosphor stripes 23a, and an aluminum film 23c is formed on the phosphor stripes 23a and the black matrix 23b, so that color reproduction is generated by the electron beam scanned to the screen 23.

Further, in the screen 23, index stripes 23d which generate index signals are formed on the aluminum film 23c at corresponding positions where the black matrix 23b is arranged.

An electron gun 25 is installed in the neck 21c and emits the electron beam toward the screen 23, a deflection unit 27 deflects the electron beam emitted from the electron gun 25 and a detector 29, senses light emitted from the index stripes 23d to transmit the light to an indexing circuit part (not shown) as electric signals. The deflection unit 27 and the detector 29 are installed on an outer periphery of the funnel 21b.

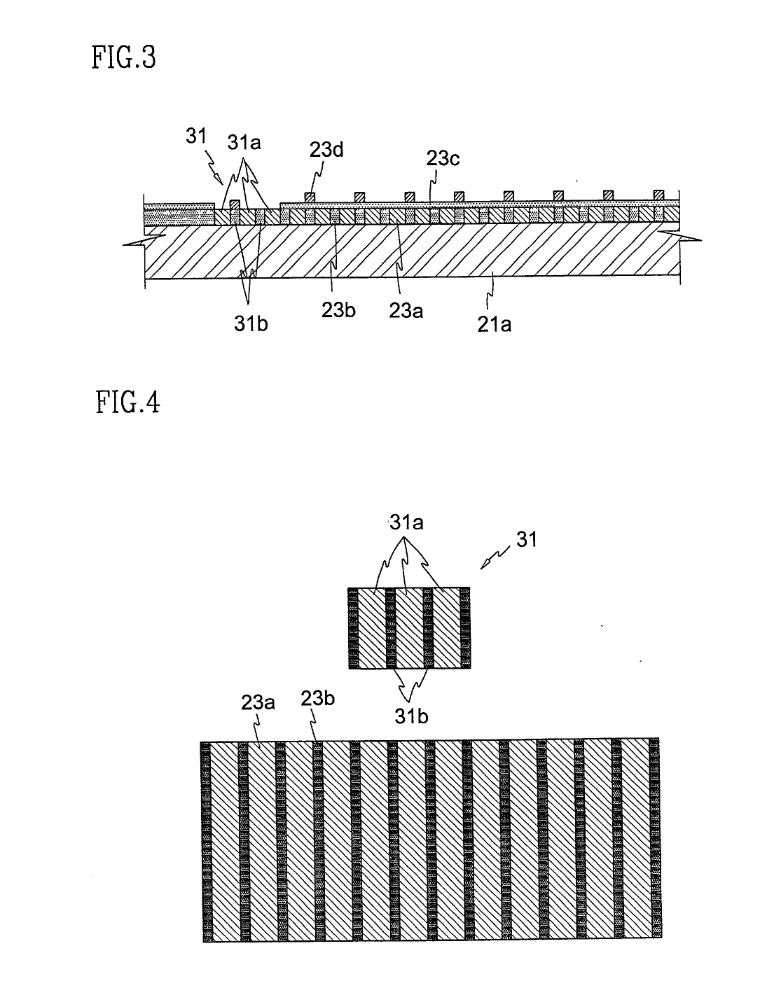

Confirming points 31 which confirm an exposure state, are formed in the screen 23 in the manufacturing process of the screen 23. See FIGS. 1 and 3.

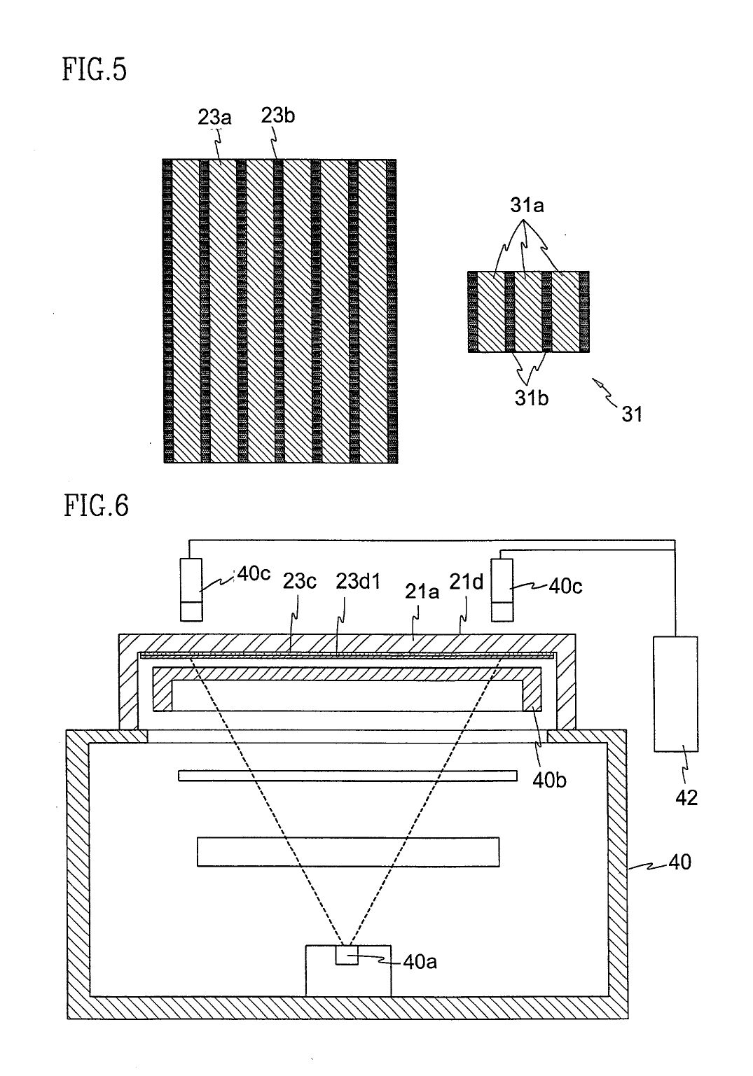

The confirming points 31 are formed to confirm the exposure state of the index stripes 23d, are arranged in a non-effective screen area 23e of the screen 23 as shown in FIG. 2 and are formed with R, G and B phosphors 31a and a black matrix 31b arranged therebetween as one set as shown in FIGS. 4 and 5.

At least one confirming point 31 is formed in longer and/or shorter axial directions of the screen 23 within the non-effective screen area 23e of the screen 23, wherein the confirming points 31 are formed in four positions A, A1,B and B1 of the screen 23 as shown in FIG. 2.

FIG. 4 and FIG. 5 are detailed views of confirming points 31 which are located in positions A and B of FIG. 2, respectively, wherein the confirming points 31 are formed on a same layer with the phosphor stripes 23a and the black matrix 23b, which are formed in an effective screen 23f, corresponding to the phosphor stripes 23a and the black matrix 23b. The confirming points 31 are offset a predetermined distance from the effective screen area 23f of the screen 23 as shown in FIG. 2.

That is, the confirming points 31 are formed with construction elements of the screen 23 when manufacturing the screen 23 during the manufacturing process of the beam index cathode ray tube.

For a more detailed description, the manufacture of the screen 23 starts from forming the black matrix 23b, wherein a photoresistive material for a photoresist layer is deposited over an inner surface of the panel 21a, an exposure operation of the photoresist layer is performed on exposure areas, and a developing operation is completed for the photoresist layer, so that the photoresist layer is formed with a predetermined pitch on the inner surface of the panel 21a.

Also, a light absorptive material for a light absorptive layer is deposited over the inner surface of the panel 23a on the photoresist layer, an etching operation is performed on the photoresist layer, and a cleaning operation is completed for the light absorptive layer, so that the black matrix 23b is formed with a predetermined pitch on the inner surface of the panel 21a.

Afterwards, a phosphor slurry is applied on the black matrix 23b, an exposure operation is performed on exposure areas, and a developing operation is completed, so that the phosphor stripes 23a are formed between the black matrix 23b. Such procedures are serially performed according to the R, G and B phosphors.

The above procedures are performed according to a general method except that the black matrix 23b and the phosphor stripes 23a are patterned to be formed as the black matrix 31b and the phosphors 31a with the confirming points 31 in the above positions. For this patterning, a suitable master glass pattern mask is provided.

After the above processes, the aluminum film 23c is formed by a vacuum evaporation with a predetermined thickness on the black matrix 23b and the phosphor stripes 23a, however as shown in FIG. 3, the aluminum film 23c is not formed on the confirming points 31.

A shielding plate (not shown) is arranged on the confirming point 31 to prevent the evaporation of the aluminum film on the confirming points 31, when evaporating the aluminum film 23c. Such an operation is more easily achieved where the confirming points 31 are arranged in the non-effective screen 23e.

Referring now to FIG. 6, the process of forming the index stripes 23d is continued. A slurry 23d1 for forming the index stripes is applied on the aluminum film 23c and an exposure operation is carried out over an exposure area, so that light, which is emitted toward the panel 21a from a light source 40a of an exposure fixture 40, arrive at the slurry for index stripe positions corresponding to the black matrix 23b. Where an operator can not observe light from light source 40a passing through the confirming points 31 when the operator watches the panel 21a on an outside surface 21d of the panel 21a, this means that the exposure procedure is properly carried out with relation to the index stripes 23d, and that a master glass pattern mask 40b is mounted with respect to the exposure area in the right position and in the proper state.

However, if the master glass pattern mask 40b is not mounted at the right position, the exposure operation becomes poorly performed, which may be confirmed using the confirming points 31 during the procedure.

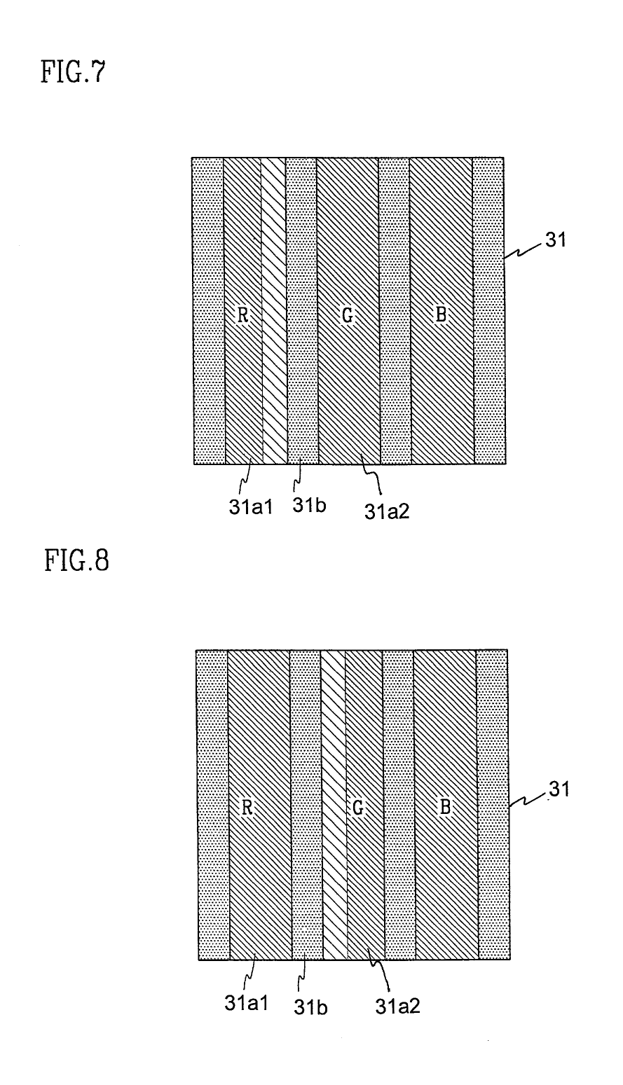

If the exposure process is poorly performed, it is possible to observe that the light beams emitted from the light source 40a become deviated from the black matrix 3 lb and partially slanted toward the fluorescent stripes 31a, as shown in FIG. 7 and FIG. 8, where the operator or a false exposure sensor 40c observes the inside of the panel 21a through the confirming points 31. Accordingly, the operator and the false exposure sensor 40c can sense the light beams which come from the phosphor stripes 31a and determine a poor exposure state of the index stripes 23d. For reference, FIG. 7 shows a false exposure toward an R phosphor strip 31a1 and FIG. 8 shows a false exposure toward a G phosphor stripe 31a2.

If the exposure process of the index stripes 23d, as described above, is badly carried out, the process is temporarily interrupted and continued after adjusting the exposure position of the index stripes 23d. During the interruption, the false exposure sensor 40c transmits a corresponding electric signal to a control part 42 as the false exposure sensor 40c senses the above incorrect exposure state. The control part 42 adjusts the relative positions of the panel 21a and the master glass pattern mask 40b to correct the false exposure position precisely and then continues the exposure operation.

As described above, in the beam index type cathode ray tube according to the present invention, the exposure processing state of the index stripes is checked while manufacturing the screen part before manufacturing of the cathode ray tube is completed. Thereby, a defective exposure process of the index stripes and loss of manufacturing costs are effectively prevented.

Although an embodiment of the present invention has been shown and described, it would be appreciated by those skilled in the art that changes may be made in this embodiment without departing from the principles and spirit of the invention, the scope of which is defined in the claims and their equivalents.

What is claimed is:

1. A beam index type cathode ray tube comprising:
a tube, having an interior which is maintained in a vacuum state;
a screen formed at one side of an inner surface of the tube and having phosphor stripes, a black matrix, an aluminum film and index stripes;
an electron gun installed in the tube and which ejects an electron beam toward the screen;
a deflection unit installed in the tube which deflects the electron beam;
a detector installed in the tube which senses light emitted from the index stripes; and
a confirming point formed in the screen, an exposed state of the screen.

2. The beam index type cathode ray tube of claim 1, wherein the confirming point is formed on a non-effective part of the screen.

3. The beam index type cathode ray tube of claim 1, wherein the confirming point comprises red R, green G and blue B phosphors and a black matrix which is formed between the phosphors.

4. The beam index type cathode ray tube of claim 3, wherein a plurality of confirming points are provided in the screen in a first axis direction of the screen.

5. The beam index type cathode ray tube of claim 4, wherein at least one confirming point is provided in a second axis direction transverse to the first axis direction.

6. The beam index type cathode ray tube of claim 3, wherein the confirming point is formed on a same layer with the phosphor stripes, and the aluminum film is formed to expose the confirming point.

7. The beam index type cathode ray tube of claim 2, further comprising another confirming point formed on the non-effective part of the screen, the confirming points formed on opposite sides of the screen.

8. The beam index cathode ray tube of claim 2, further comprising a plurality of confirming points formed on the non-effective part of the screen, the confirming points formed on opposite sides of the screen in first and second axis directions.
